(19) United States
(12) Patent Application Publication
(10) Pub. No.: US 2022/0351707 A1
(43) Pub. Date: Nov. 3, 2022

(54) METHOD AND DEVICE FOR FLATTENING POWER OF MUSICAL SOUND SIGNAL, AND METHOD AND DEVICE FOR DETECTING BEAT TIMING OF MUSICAL PIECE

(71) Applicant: Roland Corporation, Shizuoka (JP)

(72) Inventor: Satoshi Kusakabe, Shizuoka (JP)

(73) Assignee: Roland Corporation, Shizuoka (JP)

(21) Appl. No.: 17/622,236

(22) PCT Filed: Jun. 27, 2019
(86) PCT No.: PCT/JP2019/025669

§ 371 Date: Dec. 23, 2021

(51) Int. Cl. G10H 1/00

(52) U.S. Cl. CPC G10H 1/0008; G10H 2210/076; G10H 2250/235; G10H 2210/265

(57) ABSTRACT

A method for flattening power of a musical sound signal, said method being characterized by comprising: determining second values corresponding to respective first values indicating power at a plurality of time points of a musical sound signal each on the basis of the result of a comparison between the present value of the first value and the present value of the second value; and flattening the plurality of first values using the second values corresponding to the plurality of first values, respectively, wherein the second value changes while drawing a predetermined trajectory when, in the result of the comparison, a state where the present value of the second value is larger than the present value of the first value continues.

### TECHNICAL FIELD

The present invention relates to a method and a device for flattening power of a musical sound signal, and a method and a device for detecting a beat timing of a musical piece.

### RELATED ART

Conventionally, there are a waveform recording/playing method and a waveform playing device for playing a waveform data sequence based on a compression difference data sequence obtained by multiplying a sequence of differences of waveform data normalized by an envelope by a compression rate that is inversely proportional to the magnitude of fluctuation of the waveform data sequence, expansion rate data related to the compression rate, and a predetermined envelope (see, for example, Patent Literature 1). There is also a waveform signal processing device for normalizing a waveform signal and removing the envelope of the waveform signal based on the maximum value of each block of the waveform signal and its address (see, for example, Patent Literature 2).

### CITATION LIST

### Patent Literatures

[Patent Literature 1] Japanese Patent No. 2900077
[Patent Literature 2] Japanese Laid-Open No. 62-075600

### SUMMARY OF INVENTION

### Technical Problem

Attempts have been made to detect a beat of a musical piece by analyzing a musical piece signal. The beat is a basic unit of time that is inscribed at regular intervals. The beat is generally performed by identifying the time position (where the signal level/power is large) of the peak of the musical sound signal that appears periodically. Therefore, the past signal condition affects the detection (prediction) of the beat timing after the present time point.

Some musical pieces have a part in which the volume suddenly decreases at a certain time point and the state continues for a while, and the beat changes. For such musical pieces, there may be cases where the beat timing detection method used for the musical sound signals past a certain time point cannot be applied directly after a certain time point (for example, the peak cannot be detected properly due to a decrease in volume). Especially when recursive processing is used to detect the beat timing, in the beat timing detection processing after the volume is reduced, the feedback value before the volume is reduced has a large effect, which may affect the accuracy of beat timing detection.

The present invention aims to provide a musical sound signal normalization method, an information processing device, a beat timing detection method, and a beat timing detection device that can reduce the influence of a change in power (volume).

### Solution to Problem

According to one aspect of the present invention, a method for flattening power of a musical sound signal includes: an information processing device determining a second value corresponding to each of first values indicating power at a plurality of time points of the musical sound signal based on a result of comparison between a present value of the first value and a present value of the second value; and flattening the plurality of first values using the second value corresponding to each of the plurality of first values, wherein the second value changes by drawing a predetermined trajectory when a state where the present value of the second value is larger than the present value of the first value continues in the result of comparison.

According to another aspect of the present invention, an information processing device includes: a control part performing a process of determining a second value corresponding to each of a plurality of first values indicating power at a plurality of time points of a musical sound signal based on a result of comparison between a present value of the first value and a present value of the second value, and a process of flattening the plurality of first values using the second value corresponding to each of the plurality of first values, wherein the second value changes by drawing a predetermined trajectory when a state where the present value of the second value is larger than the present value of the first value continues in the result of comparison.

According to another aspect of the present invention, a method for detecting a beat timing of a musical piece includes: an information processing device determining a second value corresponding to each of a plurality of first values indicating power at a plurality of time points of a musical sound signal of the musical piece based on a result of comparison between a present value of the first value and a present value of the second value; flattening the plurality of first values using a plurality of second values corresponding to each of the plurality of first values; and detecting the beat timing using the plurality of first values flattened, wherein the second value changes by drawing a predetermined trajectory when a state where the present value of the second value is larger than the present value of the first value continues in the result of comparison.

According to another aspect of the present invention, a device for detecting a beat timing of a musical piece includes: a control part performing a process of determining a second value corresponding to each of a plurality of first values indicating power at a plurality of time points of a musical sound signal of the musical piece based on a result of comparison between a present value of the first value and a present value of the second value, a process of flattening the plurality of first values using a plurality of second values corresponding to each of the plurality of first values, and a process of detecting the beat timing using the plurality of first values flattened, wherein the second value changes by drawing a predetermined trajectory when a state where the present value of the second value is larger than the present value of the first value continues in the result of comparison.

### BRIEF DESCRIPTION OF DRAWINGS

FIG. 1 shows a configuration example of an information processing device (computer) that can operate as a beat timing detection device.

FIG. 2 shows a configuration example of a control part (beat timing detection part).

FIG. 3 is a flowchart showing a reference example of processing of a generation part.

(A) of FIG. 4 shows an example of a digital signal (also referred to as a musical piece signal) of a musical piece for 12 seconds input to the generation part, and (B) of FIG. 4 shows an example of Spx data generated from the musical piece signal of (A) of FIG. 4 by the reference example.

FIG. 5 is a flowchart showing a processing example of the generation part according to an embodiment.

FIG. 6 schematically shows a configuration for normalizing power data (Qx).

FIG. 7 shows processing of an enveloper.

FIG. 8 is a flowchart showing a processing example of the enveloper.

(A) of FIG. 9 shows Qx and Spx before normalization, and (B) of FIG. 9 shows Qx and Spx after normalization.

FIG. 10 is a flowchart showing a processing example of a calculation part.

FIG. 11 is a diagram showing an example of Spx data and a sine wave of BPM used for a Fourier transform.

FIG. 12 illustrates a relationship between a cosine wave indicating BPM and a beat generation timing.

FIG. 13 is a flowchart showing an example of a process of detecting a beat generation timing performed by a detection part.

FIG. 14 is a flowchart showing an example of a process of calculating second period data and phase data in a beat timing detection method.

FIG. 15 is a circuit diagram of Equation 3.

FIG. 16 shows an example of Spx data and a damped sine wave having a BPM frequency used for Fourier transform of Equation 3.

FIG. 17 schematically shows a circuit for calculating a wavelet transform value wₙ. (A), (B), and (C) of FIG. 18 show a relationship between Spx data and a periodic Hann window sequence.

FIG. 19 is a flowchart showing an example of a process of calculating phase data.

FIG. 20 is an explanatory diagram of a wavelet transform value.

### DESCRIPTION OF EMBODIMENTS

In the following embodiments, a method for flattening power of a musical sound signal including the following, and an information processing device having the same characteristics as the flattening method will be described. The flattening method is characterized in that an information processing device determines a second value corresponding to each of a plurality of first values indicating power at a plurality of time points of the musical sound signal based on a result of comparison between a present value of the first value and a present value of the second value; and flattens the plurality of first values using the second value corresponding to each of the plurality of first values, wherein the second value changes by drawing a predetermined trajectory when a state where the present value of the second value is larger than the present value of the first value continues in the result of comparison.

In the method for flattening the power of the musical sound signal, the power at the plurality of time points of the musical sound signal may be, for example, power of each of a plurality of samples of the musical sound signal, or power of a plurality of peaks extracted from the plurality of samples.

Further, in the method for flattening the power of the musical sound signal, the following configurations may be adopted. That is, in the comparison, after a first value larger than the present value of the second value is set as a present value of a new second value, if a present value of a first value larger than the present value of the new second value does not appear in a first period, the predetermined trajectory draws a first straight line that maintains the present value of the new second value in the first period, and further if the present value of the first value larger than the present value of the new second value does not appear in a second period continuous with the first period, the predetermined trajectory draws a second straight line in which the present value of the second value at a start point of the second period becomes 0 at an end point of the second period. In this case, when the present value of the first value is larger than the present value of the second value, the information processing device determines the first value as a corresponding second value, and when the present value of the first value is smaller than the present value of the second value, the information processing device determines the corresponding second value according to the first straight line and the second straight line, and flattening of the plurality of first values is performed by dividing each of the plurality of first values by the corresponding second value, or multiplying each of the plurality of first values by a reciprocal of the corresponding second value.

Further, in the present embodiment, a beat timing detection method and a beat timing detection device for detecting the beat timing using a plurality of flattened power obtained by the above-mentioned method for flattening the power of the musical sound signal will be described.

In the beat timing detection method, each power (intensity data) of each of the plurality of samples of the musical sound signal may indicate a sum of power of each frequency bandwidth obtained by a fast Fourier transform by acquiring a frame composed of samples of a predetermined number of continuous sound from data of the musical piece, thinning the samples in the frame, and performing the fast Fourier transform on the samples thinned. However, each power of the plurality of samples is not limited to the above.

In the beat timing detection method, each power of a plurality of peaks extracted from the plurality of samples may indicate power (referred to as intensity data) when a state where power indicating a value larger than itself, among power of each of the plurality of samples, does not appear continues for a predetermined time. In addition, the information processing device may adopt a configuration that flattens the power of the plurality of peaks; calculates a period and a phase of a beat of the musical piece using the power of the plurality of peaks flattened; and detects the beat timing of the musical piece based on the period and the phase of the beat.

In the beat timing detection method, the information processing device may adopt a configuration that performs a Fourier transform on the power of the plurality of peaks flattened for a predetermined time (a plurality of pieces of intensity data), and calculates a BPM (Beats Per Minute), as the period of the beat of the musical piece, when an absolute value of a value of the Fourier transform becomes a maximum value; and calculates a relative position, as the phase of the beat, of a generation timing of a beat sound in a sine wave indicating the BPM.

In the beat timing detection method, the information processing device may perform, with respect to a plurality of BPM, a Fourier transform having an attenuation term on the power of the plurality of peaks flattened, and calculate a BPM, as the period of the beat of the musical piece, when an absolute value of a value of the Fourier transform becomes a maximum value. In this case, the information processing device may perform the Fourier transform on a plurality of values, which are obtained by multiplying each of window functions shifted by 1/n period of the BPM corresponding to the period of the beat of the musical piece by the power of the plurality of peaks flattened, to obtain a plurality of wavelet transform values, and calculate a phase, as the phase of the beat of the musical piece, when an absolute value of the plurality of wavelet transforms becomes maximum.

In the beat timing detection method, the information processing device may obtain a count value indicating the period of the beat and the phase of the beat, time the count value using a counter that increments a sampling rate for each sample, and detect a timing at which a value of the counter reaches the count value as the beat timing.

Hereinafter, a beat timing detection device and a beat timing detection method according to the embodiments will be described with reference to the drawings. The configurations of the embodiments are examples, and the present invention is not limited to the configurations of the embodiments.

### First Embodiment

### Configuration of Beat Timing Detection Device

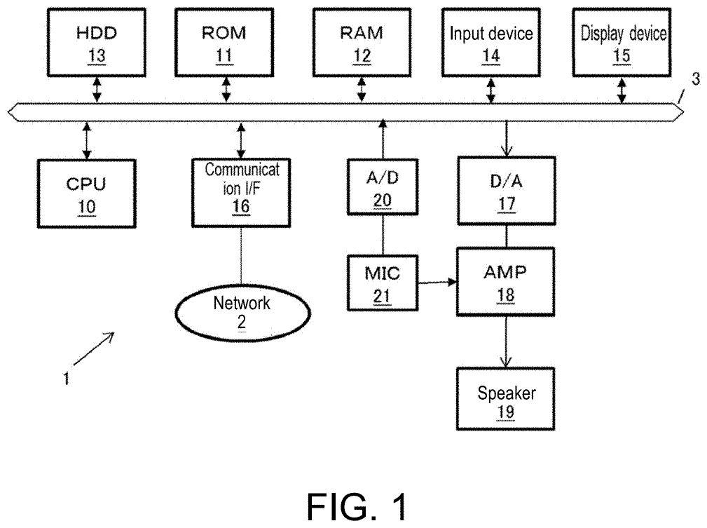

FIG. 1 shows a configuration example of an information processing device that can operate as a beat timing detection device. The information processing device 1 may be a general-purpose computer such as a personal computer (PC) or a smart device (smartphone, tablet terminal), or a dedicated computer. Further, the information processing device may be a mobile terminal that is portable or a fixed terminal.

In FIG. 1, the information processing device 1 includes a CPU 10, a ROM (Read Only Memory) 11, a RAM (Random Access Memory) 12, a hard disk drive (HDD) 13, an input device 14, a display device 15, and a communication interface (communication I/F) 16 which are connected to a bus 3. The information processing device 1 further includes a digital-to-analog converter (D/A) 17 and an analog-to-digital converter (A/D) 20 connected to the bus 3. An amplifier (AMP) 18 is connected to the D/A 17, and a speaker 19 is connected to the AMP 18. A microphone (MIC) 21 is connected to the A/D 20.

The ROM 11 stores various programs to be executed by the CPU 10 and data to be used when the programs are executed. The RAM 12 is used as an expansion area of the programs, a work area of the CPU 10, a storage area of the data, etc. The HDD 13 stores programs, data to be used when the programs are executed, musical piece data, etc. The musical piece data is sound data having a predetermined audio file format such as MP3 or WAVE format. The format of the audio file may be other than the MP3 or WAVE format. The ROM 11 and the RAM 12 are examples of the main storage device, and the HDD 13 is an example of the auxiliary storage device. The main storage device and the auxiliary storage device are examples of the storage device or the storage medium.

The input device 14 is a key, a button, a touch panel, etc., and is used for inputting information (including instructions and commands). The display device 15 is used for displaying information. The communication I/F 16 is connected to a network 2 and in charge of processing related to communication. The CPU 10 can download desired musical piece data (musical piece signal) from the network 2 and store it in the HDD 13 in response to an instruction input from the input device 14, for example.

The CPU 10 performs various processes by executing the programs. In addition to the above-mentioned processing related to musical piece download, the processes include a process related to playing of a musical piece, a process of generating a beat sound generation timing of a musical piece, a process of outputting a beat sound (for example, a clap sound, particularly a hand clap sound) in accordance with the beat sound generation timing, etc. The CPU 10 is an example of the “control part”.

For example, when playing musical piece data, the CPU 10 generates digital data (digital signal) representing the sound of the musical piece from the musical piece data read from the HDD 13 to the RAM 12 by executing the program, and supplies the digital data to the D/A 17. The D/A 17 converts the digital data representing the sound into an analog signal by digital-to-analog conversion, and outputs the analog signal to the AMP 18. The analog signal whose amplitude is adjusted by the AMP 18 is output from the speaker 19.

The MIC 21 collects, for example, a singing sound accompanied by the sound of the musical piece (karaoke) output from the speaker 19. The analog audio signal collected by the MIC 21 is amplified in amplitude by the AMP 18 and output from the speaker 19. At this time, the singing sound may be mixed with the musical piece sound or may be output from separate speakers.

Further, the MIC 21 is also used when collecting the sound produced by a performance using a musical instrument (so-called live performance) or the reproduced sound of a musical piece from an external device to enlarge (output from the speaker 19) or record the sound. For example, the signal of the performance sound collected by the MIC 21 is converted into a digital signal by the A/D 20 and passed to the CPU 10. The CPU 10 converts the signal of the performance sound into a format according to the audio file format to generate an audio file, and stores the audio file in the HDD 13. The beat timing detection process (generation of beat sound generation timing) may be performed on the sound signal of the musical piece collected by the MIC 21.

The information processing device 1 may include a drive device (not shown) for a disc-type recording medium such as a compact disc (CD). In this case, a digital signal representing the sound of the musical piece read from the disc-type recording medium using the drive device may be supplied to the D/A 17, and the musical piece sound may be reproduced. In this case, the beat timing detection process may be performed on the sound signal of the musical piece read from the disc-type recording medium.

The information processing device 1 shown in FIG. 1 can operate as a beat timing detection device. The CPU 10 operates as the control part that executes the program stored in the ROM 11 or the HDD 13 to perform a normalization process and a process of detecting the beat timing of the musical piece (generating the beat sound generation timing), which will be described later.

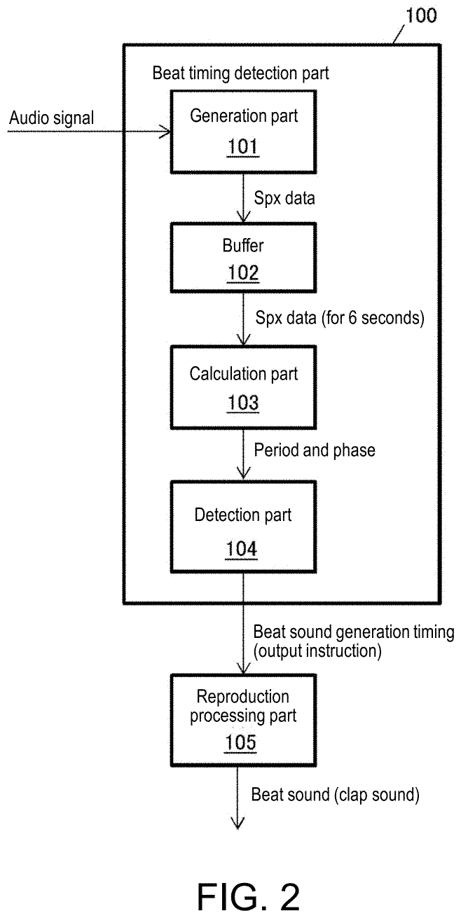

FIG. 2 is a diagram showing a configuration example of the control part (beat timing detection part). By executing the program, the CPU 10 operates as the control part (beat timing detection part) 100 shown in FIG. 2. The control part 100 operates as a generation part 101 of time sparse data (denoted as “Spx data”: power of the peak extracted from a plurality of samples, corresponding to “intensity data”), a buffer 102, a calculation part 103 for period data and phase data, and a detection part 104 of the beat timing. The buffer 102 is provided, for example, in a predetermined storage area of the RAM 12 or the HDD 13.

The generation part 101 of Spx data generates and outputs the Spx data using digital data (data of the musical piece) representing the sound of the musical piece. The buffer 102 accumulates the Spx data (corresponding to a plurality of pieces of intensity data) for at least a predetermined time. In the present embodiment, 6 seconds is exemplified as the predetermined time, but the predetermined time may be longer or shorter than 6 seconds. The calculation part 103 calculates the period data and the phase data of the beat using a set of Spx data for the predetermined time accumulated in the buffer 102. The detection part 104 of the generation timing detects the beat timing using the period data and the phase data.

The beat timing is input to a playing processing part 105 of the beat sound as the beat sound generation timing (output instruction). The playing processing part 105 performs the playing process of the beat sound in accordance with the generation timing. The operation as the playing processing part 105 is performed by, for example, the CPU 10. The buffer 102 is provided, for example, in a predetermined storage area of the RAM 12 or the HDD 13.

The generation part 101 of Spx data generates and outputs the Spx data using digital data representing the sound of the musical piece. The buffer 102 accumulates the Spx data (corresponding to a plurality of pieces of intensity data) for at least a predetermined time. In the present embodiment, 6 seconds is exemplified as the predetermined time, but the predetermined time may be longer or shorter than 6 seconds. The calculation part 103 calculates the period data and the phase data of the beat using a set of Spx data for the predetermined time accumulated in the buffer 102. The detection part 104 of the generation timing detects the beat timing using the period data and the phase data.

### «Generation of Spx Data»

The generation of Spx data performed by the generation part 101 will be described. A digital signal representing the sound of the musical piece (data sent to the D/A 17 for audio output) to be reproduced is input to the generation part 101 as “data of musical piece”. The digital signal representing the sound may be obtained by the playing process of the musical piece data stored in the HDD 13 or obtained by A/D conversion of the audio signal picked up by the MIC 21.

The digital data representing the sound is stored in the RAM 12 and used for the processing of the generation part 101. The digital data representing the sound is, for example, a set of sample (specimen) data (usually a voltage value of an analog signal) collected from an analog signal according to a predetermined sampling rate. In the present embodiment, as an example, the sampling rate is assumed to be 44100 Hz. However, the sampling rate can be appropriately changed as long as the desired FFT resolution can be obtained.

### Reference Example

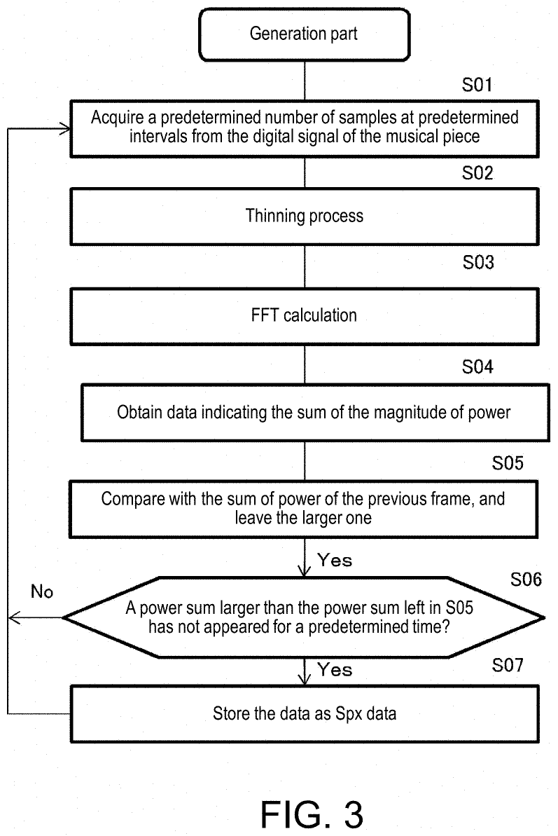

FIG. 3 is a flowchart showing a reference example of processing of the generation part 101. Digital data (digital signal) representing the sound of the musical piece, which is sent to the D/A 17 for musical sound output (playing), is input to the generation part 101. The generation part 101 acquires a predetermined number of samples (referred to as “frames”) from the input digital data (S01). The predetermined number is 1024 in the present embodiment, but may be more or fewer than this. The samples are acquired at predetermined intervals. The predetermined interval is, for example, 5 ms, but may be larger or smaller than this.

In S02, the generation part 101 performs a thinning process. That is, the generation part 101 thins the 1024 samples by ¼ to obtain 256 samples. The thinning may be other than ¼ thinning. In S03, the generation part 101 performs a fast Fourier transform (FFT) on the 256 samples, and from the result of FFT (power for each frequency bandwidth), obtains data (referred to as power data) indicating the magnitude of power in frame units (S04). Since the power is expressed by the square of amplitude, the concept of “power” includes amplitude.

The value of the power data is, for example, the sum of the power obtained by performing FFT on the 256 samples. However, if the power of the corresponding bandwidth in the previous frame is subtracted from the power of each frequency bandwidth of the present frame and the value is positive (power is increasing), the value of that power may be left for summation, and any other value (the subtracted value is negative (power is decreasing)) may be ignored. This is because there is a high possibility that the beat is where the increase in power is large.

In addition, as long as the target to be compared with other frames is the same, the value used to calculate the sum may be the sum of power of the present frame, the sum of power where the value obtained by subtracting the power of the previous frame from the power of the present frame is positive, or the difference obtained by subtracting the power of the previous frame from the power of the present frame. Further, in the power spectrum obtained by performing FFT, the above-mentioned difference calculation may be performed only for frequencies lower than a predetermined frequency. Frequencies equal to or higher than the predetermined frequency may be cut using a low-pass filter.

The power data is stored in the RAM 12 or the HDD 13 in frame units. Each time the power data in frame units is created, the generation part 101 compares the magnitude of the sum (peak value) of power with each other and leaves the larger one and discards the smaller one (S05). The generation part 101 determines whether or not a sum larger than the sum left in S05 has appeared for a predetermined time (S06). The predetermined time is, for example, 100 ms, but may be longer or shorter than 100 ms. When the state where data indicating a larger sum has not appeared continues for a predetermined time, the generation part 101 extracts data indicating the sum of power as Spx data and stores (saves) the data in the buffer 102 (S07). As described above, the Spx data is data obtained by extracting the peak values of the digital data indicating the musical sound at intervals of 100 ms, and is data indicating information indicating the timing that controls the beat of the musical piece (timing information) and the power at that timing. A plurality of pieces of Spx data are accumulated in the buffer 102. The generation part 101 repeats the processes from S01 to S06.

(A) of FIG. 4 is a digital signal of a musical piece for 12 seconds input to the generation part 101, and (B) of FIG. 4 shows an example of the Spx data generated by the processing of the reference example from the digital signal of the musical piece shown in (A) of FIG. 4. The horizontal axis of the graph shown in (B) of FIG. 4 is time, and the vertical axis is power. In this graph, the vertical line with a black circle at the top indicates the individual Spx data obtained from the digital signal of the musical piece shown in (A) of FIG. 4, the position on the horizontal axis (time axis) indicates the timing, and the length of the vertical line indicates the power. The Spx data is generated at predetermined intervals (for example, 100 ms or larger), and usually about 6 pieces are generated per second.

### (Normalization Process)

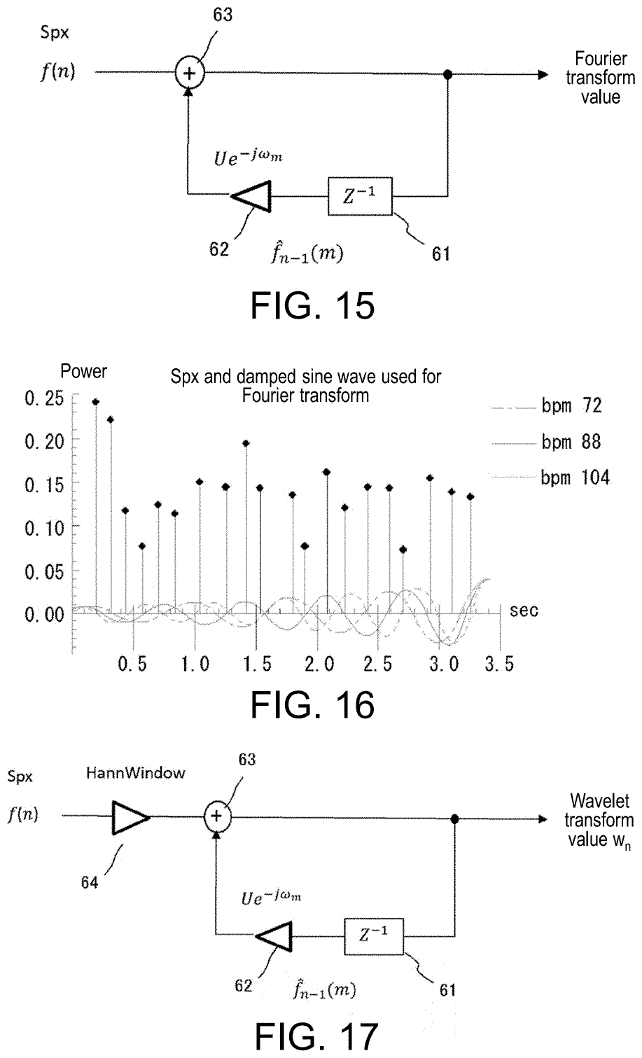

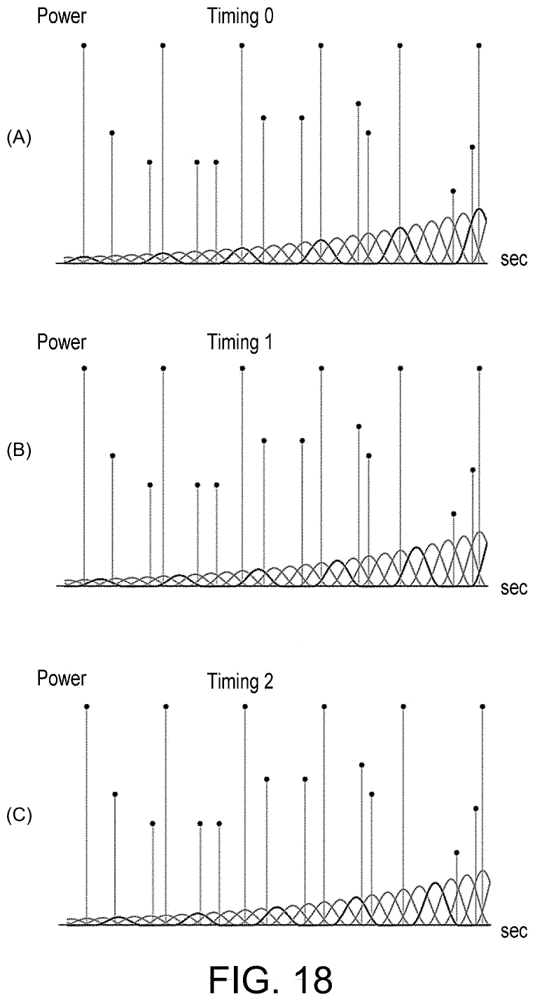

In the above-mentioned reference example, a plurality of Spx data values as shown in (B) of FIG. 4 can be obtained. However, as shown in the central portion of (B) of FIG. 4, the value of the Spx data (intensity data) may suddenly decrease to a small value at a certain timing. In such a case, an appropriate value may not be obtained in calculation of the period and phase of the beat, which will be described later. As will be described later, for example, when a recursive process (FIG. 15 and FIG. 17) is performed in calculating the period and phase of the beat, the larger Spx data value before the change may become dominant in the processing related to the Spx data immediately after the change, resulting in that the change of the Spx data cannot be properly followed.

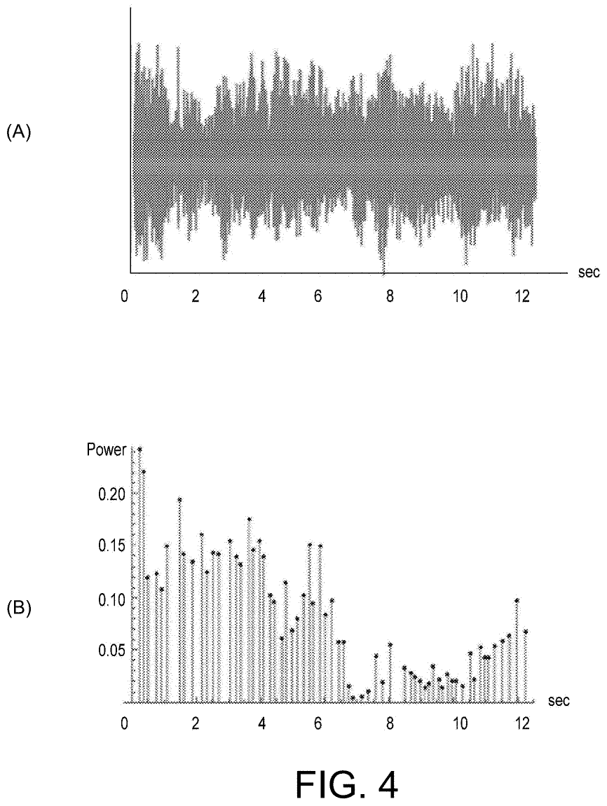

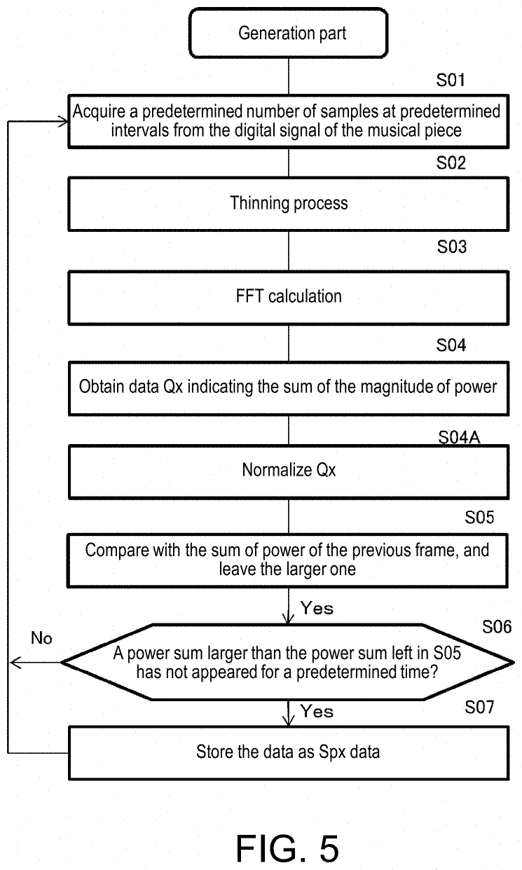

In the present embodiment, in order to solve the above-mentioned problem, a normalization process for Spx data (a process of flattening the size of Spx data or a process of reducing the difference) is performed. FIG. 5 is a flowchart showing a processing example of the generation part 101 according to an embodiment. The processing of FIG. 5 differs from the reference example in that the normalization process (S04A) is provided between S04 and S05 in the reference example.

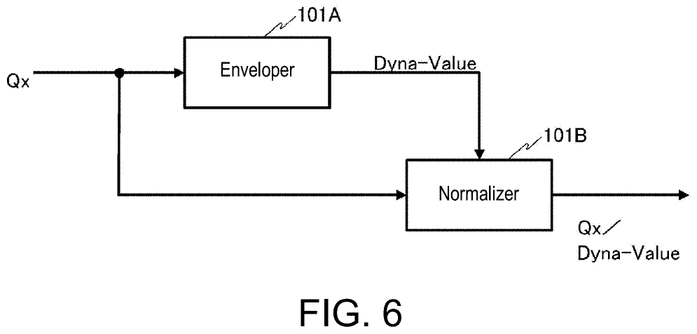

FIG. 6 schematically shows a configuration related to the normalization process performed by the generation part 101. The normalization process has an enveloper 101A and a normalizer 101B. The data (power data) indicating the magnitude (sum) of power in frame units described in the reference example is “Qx”. A set of Qx arranged in chronological order on the time axis corresponds to “a plurality of musical sound signals”. Each of the plurality of pieces of Qx is input to the enveloper 101A and the normalizer 101B. Qx corresponds to “first value” and “power of each of a plurality of samples”.

The enveloper 101A uses the value of Qx to obtain and calculate a dynamics value (Dv) corresponding to Qx. The dynamics value Dv is a value indicating a change in the strength of the sound with respect to Qx, and is an example of a “normalization signal (second value)”.

The normalizer 101B obtains the normalized value of Qx by dividing the value of Qx by the value of Dv (Qx/Dv).

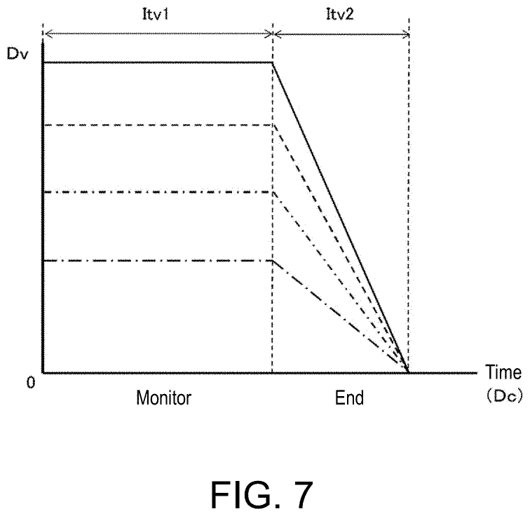

FIG. 7 is an explanatory diagram of the processing of the enveloper 101A. The enveloper 101A maintains a constant value as long as the state where the value of the musical sound signal is attenuated continues for a predetermined time (monitoring section: first period (first interval) Itv1) (the trajectory of the value Dv in the first period draws a straight line (first straight line) in which the value of Dv is constant). Then, when the predetermined time passes, regardless of the magnitude of Dv at that time, the value of Dv is calculated so that the value of Dv ends (converges) at one point (0) in a certain time (second period (second interval) Itv2 continuous with the first period). That is, the trajectory of the value of Dv in the second period draws a straight line (second straight line) having a slope in which the value of Dv at the start point of the second period becomes 0 at the end point of the second period. The trajectory composed of the first and second straight lines is an example of the “predetermined trajectory”, but the shape of the “predetermined trajectory” is not limited to the above example.

The “predetermined time” is determined as follows. Beat detection is performed by identifying the time position of the peak of a musical sound that appears periodically. Therefore, if the normalization signal changes in a time shorter than the period of the peak of the musical sound (following the musical sound signal), there is a high possibility that a peak shorter than the original beat period will be detected. Therefore, the “predetermined time” needs to be longer than the beat period. On the other hand, if the “predetermined time” is set too long, the influence hardly disappears when the volume changes from a high volume state to a low volume state. The “predetermined time” is determined in consideration of these.

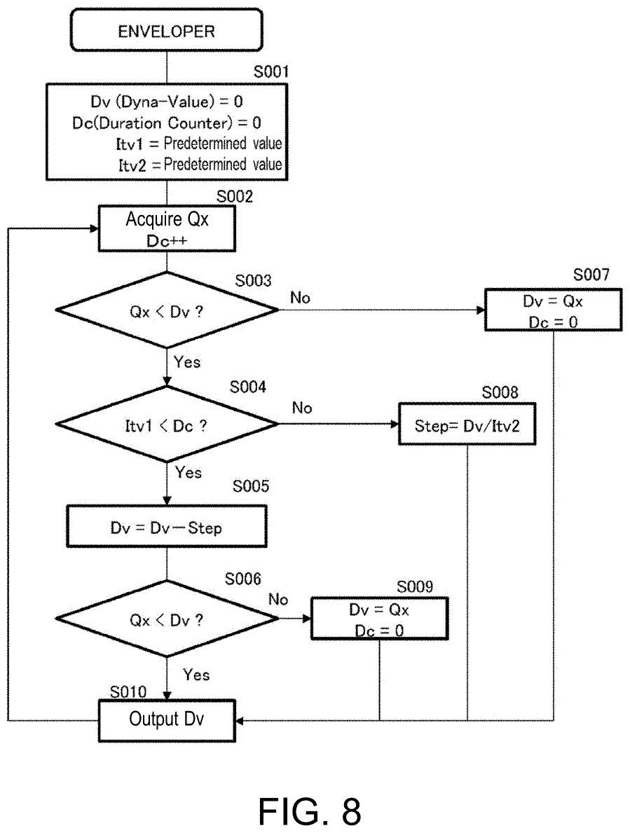

FIG. 8 is a flowchart showing a processing example of the enveloper 101A. In S001, the following processing is performed as an initial setting.
Set the value indicating the change in the strength of the sound (dynamics value: Dyna-value: Dv) to 0.
Set the value of the duration counter (Duration Counter: Dc) to 0. Dc indicates the position on the time axis of the graph shown in FIG. 7.
Set the values of Itv1 and Itv2 shown in FIG. 7 to predetermined values.

In S002, the value of Qx obtained in S04 (FIG. 5) is acquired, and the value of Dc is incremented. In S003, the value of Qx and the value of Dv are compared to determine whether the value of Dv is larger than the value of Qx. If it is determined that the value of Dv is larger than the value of Qx, the processing proceeds to S004, and if it is determined otherwise, the processing proceeds to S007.

When the processing proceeds to S007, the value of Dv is set equal to the value of Qx (the value of Dv is increased), and the value of Dc is set to 0 (reset). Thereafter, the processing proceeds to S010. In S010, the present value of Dv is output and the processing is returned to S002.

When the processing proceeds to S004, it is determined whether the value of Dc is larger than the value of Itv1. If it is determined that the value of Dc is larger than the value of Itv1, the processing proceeds to S005. On the other hand, if it is determined that the value of Dc is smaller than the value of Itv1, the processing proceeds to S008. When the value of Dc is larger than the value of Itv1, it means that the value of Dc reaches the monitoring time (a predetermined time after the value of the musical sound signal starts to decrease) Itv1.

In S008, a value obtained by dividing the value of Dv by the value of Itv2 is set to the value of “Step”. The value of Step indicates the slope of Dv in the section 2. Thereafter, the processing returns to S010.

If it is determined in S004 that the value of Dc is larger than the value of Itv1, it means that the position of Qx on the time axis is within the second section Itv2. In S005, the value of Step is subtracted from the value of Dv. In the process of S005, a process of reducing the value of Dv is performed according to a straight line (slope obtained in S008) in which the present value of Dv becomes 0 at the end point of Itv2. That is, the value of Dv is set to a value corresponding to the present value of Dc on the above-mentioned straight line.

In S006, it is determined whether the value of Dv is larger than the value of Qx. If it is determined that Dv is larger than Qx, the processing proceeds to S010, and if it is determined otherwise, the processing proceeds to S009. In S009, the value of Qx is set to the value of Dv, and the value of Dc is set to 0 (reset). Thereafter, the processing proceeds to S010.

(A) of FIG. 9 shows the relationship between Qx and Dv. In (A) of FIG. 9, the gray part shows the temporal change of Qx (a plurality of Qx), and the bar graph with a black circle at the top shows Spx. Then, the broken line indicates the change of Dv. As shown in (A) of FIG. 9, the value of Qx sharply decreases around 9.8 [sec], and continues to be a small value. In the processing of FIG. 8, if Qx is larger than Dv, Dv is increased. Further, if Qx is smaller than Dv, Dc is counted up until Dc exceeds Itv1. During this time, the value of Dv does not change (maintain the value of Dv: see around 9.4 to 10.1 on the horizontal axis). When Dc exceeds Itv1 (the position of Qx on the time axis is within Itv2), the value of Dv is reduced according to the slope of “Dv/Itv2”. Since the slope is constant, Dv decreases in a straight line until Qx exceeds Dv again (see around 10.1 to 10.5 on the horizontal axis).

(B) of FIG. 9 shows the Qx and Spx normalized by the normalizer 101B. For example, in (A) of FIG. 9, when Dv=0.08 with respect to Qx=0.08, the value of Qx normalized by the calculation (Qx/Dv) of the normalizer 101B is 1.0. On the other hand, if Dv=0.005 when Qx=0.005, the normalized value of Qx is 1.0. In this way, even if the power is sharply reduced by the normalization of Qx, the value is about the same when viewed in terms of the change in the strength of the sound.

The processing of S05 to S07 of FIG. 5, that is, the processing for obtaining Spx is performed using the normalized Qx. The Spx shown in (B) of FIG. 9 is obtained by the processing of S05 to S07 using the normalized Qx obtained in S04A. After calculating Spx, the above-mentioned normalization process may be performed on Spx.

### «Effect of Normalization (Flattening) Process»

As described above, the information processing device 1 determines Dv (corresponding to the second value) corresponding to each of Qx (corresponding to the first value indicating the power at a plurality of time points of the musical sound signal) based on the result of comparison between the present value of Qx and the present value of the value of Dv. In the present embodiment, Qx is normalized by “Qx/Dv (calculation of dividing the first value by the corresponding second value)”. However, the calculation may be that the first value is multiplied by the reciprocal of the second value (Qx*1/Dv). The value of Dv used for normalization changes by drawing a predetermined trajectory when the state where the present value of Dv is larger than the present value of Qx continues in the result of comparison. The predetermined trajectory is composed of, for example, the first straight line in the first period (Itv1) and the second straight line in the second period (Itv2) as shown in FIG. 7. By using such Dv, the value of Dv corresponding to each of a plurality of Qx is obtained, and by performing the calculation of Qx/Dv, the value of Qx is flattened. By such flattening of Qx (Spx obtained by using Qx), it is possible to suppress the change in the volume of the musical piece from affecting the accuracy of beat detection. In particular, when the recursive process (FIG. 15 and FIG. 17), which will be described later, is performed, it is possible to suppress the feedback signal from causing a large influence.

### «Calculation of Period Data and Phase Data»

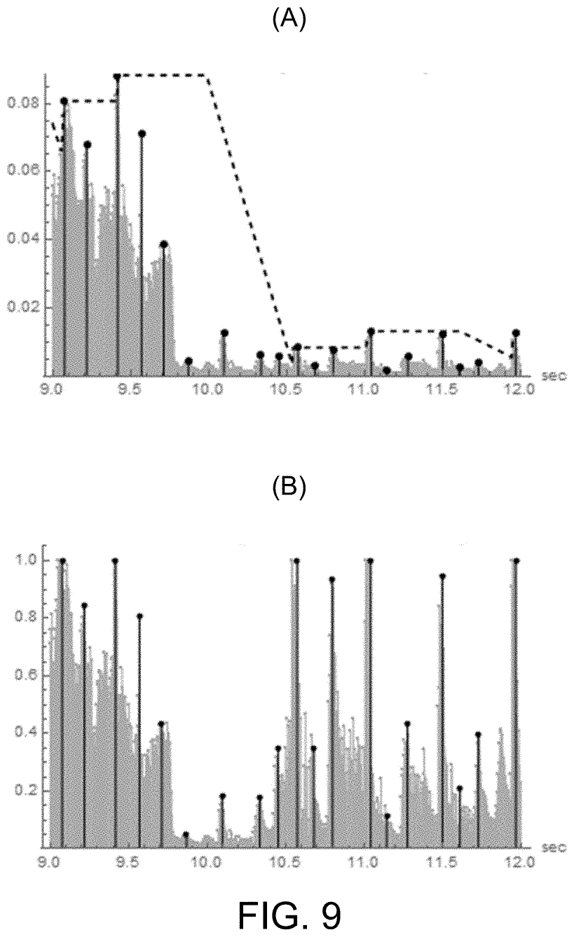

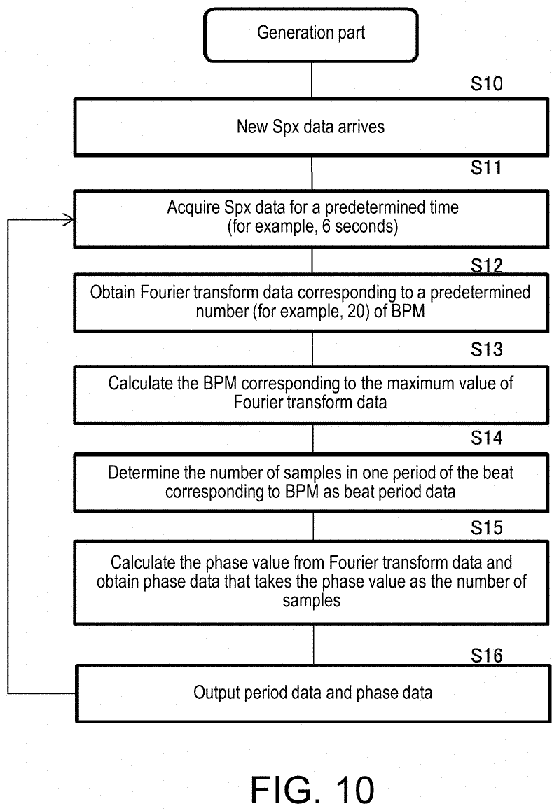

Next, a method of calculating the period and phase of the beat (first method) will be described. FIG. 10 is a flowchart showing a processing example of the calculation part 103. In S10, new Spx data generated by the generation part 101 arrives at the buffer 102 and is accumulated. In S11, Spx data for a predetermined time (corresponding to a plurality of pieces of intensity data), among the Spx data accumulated in the buffer 102, is acquired from the buffer 102. The predetermined time is, for example, 6 seconds, but may be longer or shorter than 6 seconds as long as the period and phase of the beat can be obtained. The subsequent processing of S12 to S16 is processing performed using the Spx data of 6 seconds acquired in S11. In S12, a Fourier transform corresponding to a predetermined number (for example, 20) of BPM (Beats Per Minute: indicating tempo (speed of rhythm)) is applied to the Spx data of 6 seconds to calculate the beat period (one period of BPM) and the beat phase (beat sound generation timing).

Specifically, with respect to the Spx data of 6 seconds, the sum of products for Exp (2πjft) (sine wave oscillating at BPM frequency, amplitude is the same regardless of frequency) is taken for a predetermined number (for example, 20 corresponding to BPM 86 to 168) of frequencies corresponding to BPM (BPM frequencies) f={86, 90, 94, . . . , 168}/60. That is, a Fourier transform is performed. The result of the Fourier transform is Fourier transform data c(i) (i=0, 1, 2, 3, . . . , 19).

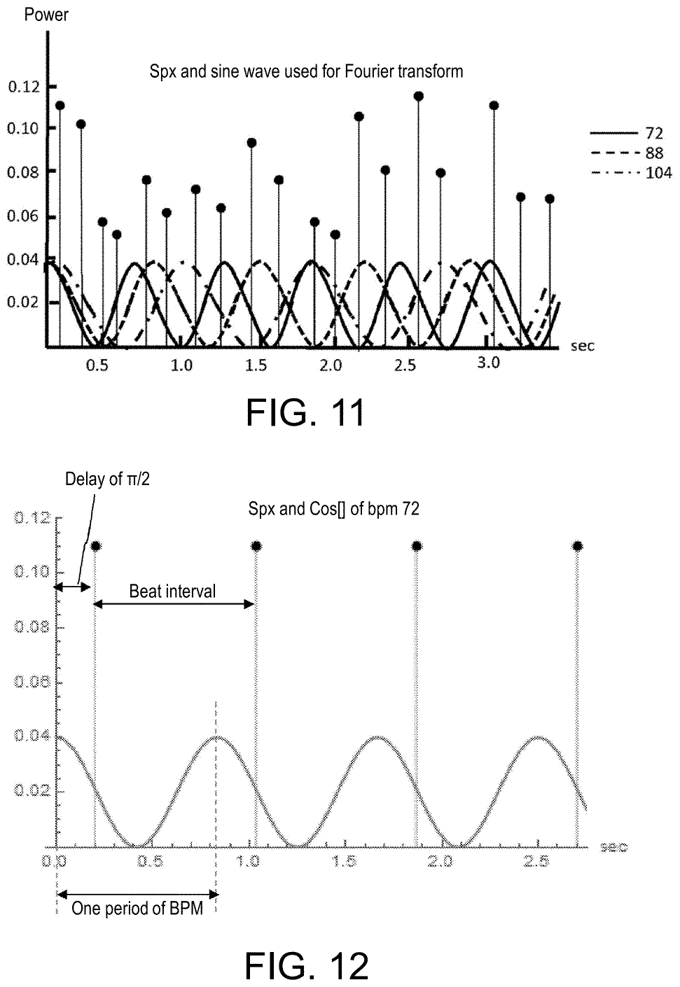

FIG. 11 is a diagram showing an example of Spx data and a sine wave having a BPM frequency used for a Fourier transform. In the example of FIG. 10, a sine wave of BPM 72 (shown by a solid line), a sine wave of BPM 88 (shown by a broken line), and a sine wave of BPM 104 (shown by a dot chain line) are exemplified. The value of the Fourier transform data c(i) is obtained by the following Equation 1. The BPM value and the number thereof can be changed as appropriate.

$$\begin{matrix}[ Equation 1 ] & \\ c ( i ) = {\sum }_{k = 1}^{M} x ( t ( k ) ) Exp ( 2 π jf ( i ) t ( k ) ) & ( 1 )\end{matrix}$$

Here, t(k) in Equation 1 is a time position in the past 6 seconds in which Spx data exists, and the unit is seconds. k is the index of the Spx data, and k=1, . . . , M (M is the number of pieces of Spx data). Further, x(t(k)) indicates the value (magnitude of the peak value) of the Spx data at that moment. j is an imaginary unit (j²=−1). f(i) is the BPM frequency and, for example, BPM 120 is 2.0 Hz.

The calculation part 103 determines the BPM whose absolute value corresponds to the maximum value, among c(i)=(c0, 1, c2, c3, . . . , c19) as the BPM of Spx data (beat) (S13). Further, the phase value (Phase)φ=Arg(c(i))[rad] is set as the beat timing for the Spx data of 6 seconds. The beat timing indicates the relative position with respect to the beat generation timing that arrives periodically.

The phase value φ is an argument of a complex number, and is obtained by the following Equation 2 when c=cᵣₑ+j cᵢₙ, (cᵣₑ is a real part and cm, is an imaginary part).

$$\begin{matrix}[ Equation 2 ] & \\ Arg ( c ( i ) ) = \{ \begin{matrix}A r c T a n ( \frac{{c}_{i m}}{{c}_{r e}} ) {c}_{re} \geq 0 , & {c}_{i m} \geq 0 \\ ArcTan ( \frac{{c}_{i m}}{{c}_{r e}} ) + π & {c}_{r e} < 0 \\ ArcTan ( \frac{{c}_{i m}}{{c}_{r e}} ) + 2 π {c}_{re} \geq 0 , & {c}_{im} < 0\end{matrix} & ( 2 )\end{matrix}$$

By calculating the phase value φ, it is possible to know the relative position of the beat generation timing with respect to the sine wave of BPM, that is, how much the beat generation timing is delayed with respect to one period of BPM.

FIG. 12 illustrates the relationship between a cosine wave indicating BPM (the real part of EXP(2πjft)) and the beat generation timing. In the example shown in FIG. 12, the number of pieces of Spx data is 4, and the BPM thereof is 72. Each of the Spx data shown in FIG. 12 is a value (phase) of c(i) obtained by using Equation 2, and indicates a beat generation timing. The interval between Spx data forms the interval between the beat generation timings. In the example shown in FIG. 12, the timing obtained by calculating the phase value φ, which is π/2 delayed from the cosine wave having the BPM frequency, is the beat generation timing. The calculation part 103 takes the number of samples in one period of BPM as period data (S15).

For example, when the BPM is 104 and the sampling rate is 44100 Hz, the period data (number of samples) is 44100 [pieces]/(104/60)=25442 [pieces]. In addition, when the period data is 25442 [pieces] and when the phase value φ is 0.34 [rad], the phase data (number of samples) is 25442 [pieces]×0.34 [rad]/2π [rad]=1377 [pieces]. Then, the calculation part 103 outputs the period data and the phase data (S16). The calculation part 103 repeats the processing of S11 to S16 every time Spx data of 6 seconds is accumulated. Thereby, it is possible to follow the change in the rhythm of the musical piece.

### «Detection of Beat Timing»

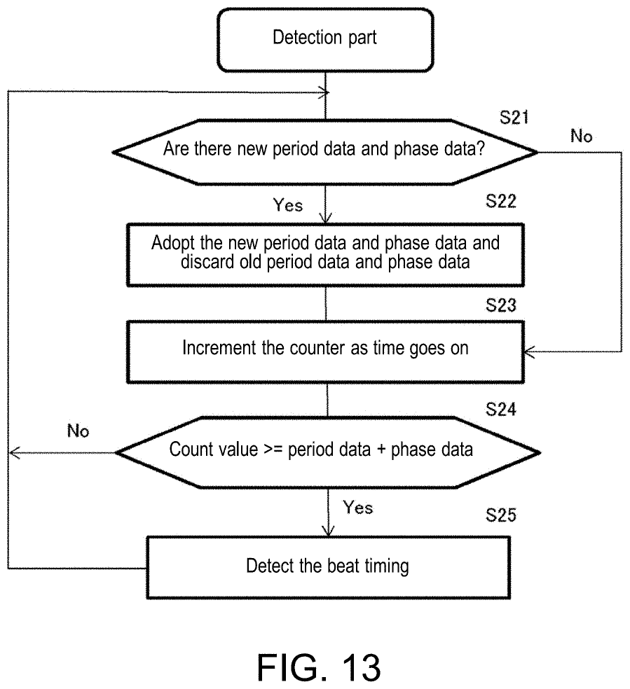

FIG. 13 is a flowchart showing an example of a beat timing detection process performed by the detection part 104. In S21, the detection part 104 determines whether new period data and phase data are provided by the calculation part 103. If new period data and phase data are provided, the processing proceeds to S22; otherwise, the processing proceeds to S23.

In S22, the detection part 104 adopts the new period data and phase data for detecting the beat generation timing, and discards the old period data and phase data. At this time, at the time of creating Spx data, the samples of the frames forming the Spx data are in a state where a delay of 100 ms is given. Therefore, here, time adjustment (phase adjustment) is performed so that the musical piece being played or reproduced, the rhythm, and the hand clap sound described later match. Thereafter, the processing proceeds to S23.

In S23, the counter is set using the number of samples of the period data and the number of samples of the phase data. For example, the detection part 104 has a counter that counts up (increments) each sample of the sampling rate (interval of voltage check of the analog signal according to the sampling rate), and increments the count value of the counter for each sample. As a result, it waits for the count value to change from zero to a predetermined value (a value indicating the sum of the number of samples of the phase data (count value) and the number of samples of the period data (count value)) or more (S24).

When the count value of the counter becomes equal to or higher than the predetermined value, the detection part 104 detects the beat sound generation timing (beat timing) based on prediction (S25). The detection part 104 notifies the control part 53 of the occurrence of the beat timing and outputs a beat sound output instruction (S25). The control part 53 performs the operation (change of display mode) described in the first embodiment based on the beat timing. The playing processing part 105 sends digital data of the beat sound (for example, hand clap sound) stored in advance in the ROM 11 or the HDD 13 to the D/A 17 in response to the output instruction. The digital data is converted into an analog signal by the D/A 17, has the amplitude amplified by the AMP 18, and then output from the speaker 19. As a result, the hand clap sound is output over the musical piece being reproduced or played.

According to the beat timing detection method described above, the reproduced or played (past) musical piece is input to the generation part 101, and the generation part 101 generates Spx data. Such Spx data is accumulated in the buffer 102, and the calculation part 103 calculates the beat period and phase from a plurality of pieces of Spx data for a predetermined time (6 seconds), and the detection part 104 detects and outputs the beat timing according to the musical piece (voice) being reproduced or played. Further, the playing processing part 105 can output a hand clap sound that matches the rhythm of the musical piece being reproduced or played. The automatic output of this hand clap sound can be performed by a simple algorithm with a small amount of calculation, such as generation of the Spx data, calculation of the beat period and phase based on Fourier transform data, and counting of the counter value described above. As a result, it is possible to avoid an increase in the load on the processing execution subject (CPU 10) and an increase in the memory resources. Further, since the amount of processing is small, it is possible to output a clap sound with no delay for the reproduced sound or played sound (even if there is a delay, the delay cannot be recognized by people).

Furthermore, since the values of Qx and Spx data are normalized by the normalization process, even if the power drops sharply, the beat timing can still be detected using the Spx value, which is little affected. The normalization of Spx may be performed by storing the Dv corresponding to Qx and dividing the value of Spx by the corresponding value of Dv (Spx/Dv) when Spx is calculated from Qx. Further, the normalization may be performed on data for detecting the beat timing, other than Spx.

The processing performed by the beat timing detection part 100 may be performed by a plurality of CPUs (processors) or by a CPU having a multi-core configuration. Further, the processing performed by the beat timing detection part 100 may be executed by a processor other than the CPU 10 (DSP, GPU, etc.), an integrated circuit other than the processor (ASIC, FPGA, etc.), or a combination of the processor and the integrated circuit (MPU, SoC, etc.).

### Second Embodiment

Next, the second embodiment will be described. The second embodiment uses a method different from the first method described in the first embodiment, as a method for calculating the beat period and phase. However, in the second method, the Spx data normalized by the method described in the first embodiment is also used. The second method differs from the first method in the calculation of period data and phase data as follows.

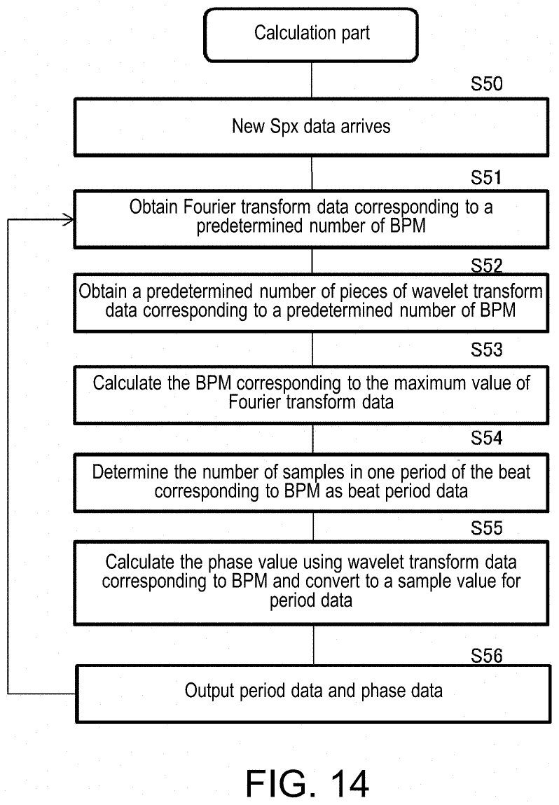

FIG. 14 is a flowchart showing an example of a process of calculating period data and phase data in the second beat timing detection method. In S50, the new Spx data generated by the generation part 101 arrives at the buffer 102.

In S51, the calculation part 103 obtains Fourier transform data corresponding to a predetermined number of BPM. In the first method, regarding the calculation of period data and phase data, a Fourier transform corresponding to a predetermined number (for example, 20 to 40) of BPM (Beats Per Minute: indicating tempo (speed of rhythm)) is applied to Spx data of 6 seconds (FIG. 9, S12).

On the other hand, in the second method (S51), a Fourier transform having an attenuation term U^{k} is used instead of the Fourier transform used in the first method. The Fourier transform equation (Equation 3) is shown below.

$$\begin{matrix}[ Equation 3 ] & \\ \hat{{f}_{n}} ( m ) = {\sum }_{k = 0}^{∞} {( {Ue}^{- j {ω}_{m}} )}^{k} f ( n - k ) = {Ue}^{- j {ω}_{m}} {\hat{f}}_{n - 1} ( m ) + f ( n ) & ( 3 )\end{matrix}$$

In Equation 3, U indicates the amount of attenuation per sample, and is a number close to 1. U indicates the rate at which past data is forgotten. The section is up to the infinity of the past. FIG. 15 is a circuit diagram of Equation 3. The past signal fₙ₋₁(m) delayed by the present delay block (Z⁻¹) 61 is multiplied by the attenuation term Ue^{-jωm} in a multiplier 62, and added with the present signal f(n) by an adder 63. In this way, the Fourier transform value per sample is obtained.

The Fourier transform value of Equation 3 can be expressed by Equations 4 and 5 below.

[Equation 4]

\hat{f}ₙ(m)=qₘ\hat{f}ₙ₋₁(m)+f(n) (4)

qₘ=Ue^{-jω}^{ₘ} (5)

For the section (empty section) where L (L is a positive integer) samples pass without the arrival of the value of Spx, the Fourier transform values for the L samples can be obtained using the following Equations 6 and 7 without using Equation 3 (the circuit shown in FIG. 15). The value of qₘ^{L} in Equation 6 can be easily obtained using Equation 7. f(n) is the value of Spx data, L is the arrival interval of Spx data, U is the attenuation coefficient, and ωₘ is the angular frequency per sample corresponding to BPM.

[Equation 5]

\hat{f}ₙ(m)=qₘ^{L}\hat{f}_{n-L}(m)+f(n) (6)

qₘ^{L}=U^{L}e^{-jω}^{ₘ}^{L} (7)

FIG. 16 shows an example of Spx data and a damped sine wave having a BPM frequency used for the Fourier transform of Equation 3. In the example of FIG. 16, the wave having the longest period is the wave of BPM 72, the next wave is the wave of BPM 88, and the wave having the shortest period is the wave of BPM 104. In the second method, a predetermined number of a plurality of BPM (for example, 20) are prepared, and a Fourier transform value using the above Equation 3 is obtained for each BPM. The number of BPM may be larger or smaller than 20.

In the second method, unlike the first method, it is not required to accumulate Spx data for a predetermined period (6 seconds). Therefore, the storage area of the memory (storage device 57) for accumulating Spx data can be effectively utilized. Further, in the first method, the product-sum calculation of a plurality of BPM×Spx data number is performed, whereas in the second method, the calculation of Equation 3 is performed for each BPM, so the amount of calculation can be significantly reduced.

In S52, the calculation part 103 obtains a predetermined number (for example, 5) of wavelet transform values corresponding to a predetermined number (for example, 20) of BPM. FIG. 17 schematically shows a circuit for calculating the wavelet transform value wₙ. The circuit has a configuration in which the multiplier 64 is added to the circuit for calculating the Fourier transform value shown in FIG. 14. The multiplier 64 multiplies the Spx data by a periodic Hann window sequence having the number of samples corresponding to the BPM value as the period. The Fourier transform of Equation 3 described above is performed on the output of the multiplier 64, and the result is output as the wavelet transform value wₙ. The Hann window is an example of a window function, and in addition to the Hann window, a triangular window or a humming window can be applied.

The wavelet transform value wₙ is obtained for each BPM for a timing shifted by ⅕ period of each BPM. That is, a periodic Hann window sequence shifted by ⅕ period of BPM is prepared, and a wavelet transform value {wₙ} 0≤n<5 corresponding to each periodic Hann window sequence is obtained.

(A), (B), and (C) of FIG. 18 show the relationship between Spx data and the periodic Hann window sequence. In (A) of FIG. 18, related to a certain BPM, a damped sine wave indicating a periodic Hann window sequence at the timing 0 is shown by a thick line, and a damped sine wave indicating a periodic Hann window sequence other than the timing 0 is shown by a thin line. In (B) of FIG. 18, related to a certain BPM, a damped sine wave indicating a periodic Hann window sequence at the timing 1 (advanced by ⅕ period from the timing 0) is shown by a thick line, and a damped sine wave indicating a periodic Hann window sequence other than the timing 1 is shown by a thin line. In (C) of FIG. 18, related to a certain BPM, a damped sine wave indicating a periodic Hann window sequence at the timing 2 (advanced by ⅕ period from the timing 1) is shown by a thick line, and a damped sine wave indicating a periodic Hann window sequence other than the timing 1 is shown by a thin line.

In S53, similar to S13, the calculation part 103 determines the BPM corresponding to the Fourier transform value having the maximum absolute value among the Fourier transform values corresponding to the plurality of BPM as the BPM of the Spx data (beat). Further, the calculation part 103 determines the number of samples in one period of the beat of the determined BPM as the beat period data (S54).

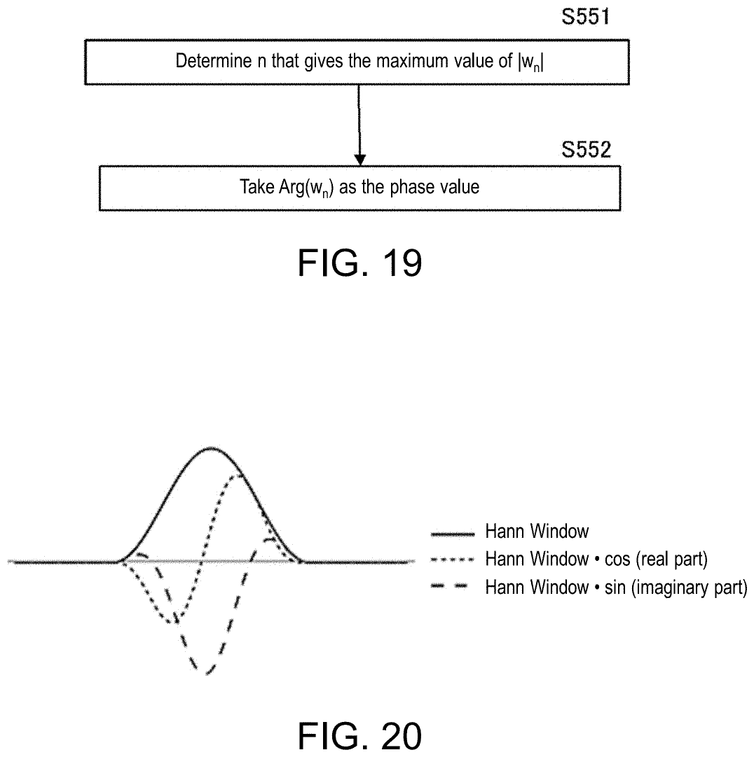

In S55, the calculation part 103 calculates the phase value from a predetermined number of wavelet transform values corresponding to the BPM, and converts the phase value into a sample value for the period data. That is, the calculation part 103 obtains the n when the absolute value of the wavelet transform value wₙ becomes maximum (S551 in FIG. 19), and obtains the phase value Arg(wₙ) corresponding to n (S552 in FIG. 19). The calculation part 103 converts the phase value into a sample value (phase data) for the period data (S55), and outputs the period data and the phase data (S56).

FIG. 20 is an explanatory diagram of the wavelet transform value. The wavelet transform value is unevenly distributed over time and has complex phase information. That is, the wavelet transform value has a curve of the Hann window, a curve related to the product of the Hann window and the real part (cosine), and a curve related to the product of the Hann window and the imaginary part (sine). In the present embodiment, by using a plurality of wavelet transform values whose timings are shifted by ⅕ period (n=5) with respect to one piece of Spx data (beat), the phase of the beat can be detected more accurately. Since the beat timing detection process is the same as that of the first method (FIG. 12), the description thereof will be omitted.

According to the second method for obtaining the period and phase in the second embodiment, compared with the first method, the storage capacity and the amount of calculation required for processing can be reduced, and the phase (beat timing) detection accuracy is improved. In particular, in the second method, the delay block retains the Fourier transform value of the previous Spx. Therefore, in the value before normalization, when the power drops sharply, the previous value retained by the delay block 61 becomes dominant in the calculation of the present value, and does not reflect the sharp drop. By normalizing Spx, there is no big difference in the value of Spx before and after the change, so an appropriate Fourier transform value or wavelet transform value can be obtained (the accuracy of these values is improved).

In the above-described embodiments, a plurality of Qx (power of each of a plurality of samples) of a musical sound signal are flattened by the normalization process, and a plurality of flattened Spx (power of a plurality of peaks) are obtained using the flattened Qx values. In contrast thereto, Spx may be obtained using the Qx before normalization, and a plurality of flattened Spx may be obtained by performing the normalization process on the Spx.

### REFERENCE SIGNS LIST

1 . . . Information processing device
2 . . . Network
10 . . . CPU
11 . . . ROM
12 . . . RAM
13 . . . HDD
14 . . . Input device
15 . . . Display device
16 . . . Communication interface
17 . . . Digital-to-analog converter
18 . . . Amplifier
19 . . . Speaker
20 . . . Analog-to-digital converter
21 . . . Microphone
100 . . . Beat timing detection part
101 . . . Generation part
102 . . . Buffer
103 . . . Calculation part
104 . . . Detection part
105 . . . Playing processing part

1. A method for flattening power of a musical sound signal, comprising:
determining a second value corresponding to each of a plurality of first values indicating power at a plurality of time points of the musical sound signal based on a result of comparison between a present value of the first value and a present value of the second value; and
flattening the plurality of first values or reducing the difference of the plurality of first values by using the second value corresponding to each of the plurality of first values,
wherein the second value changes by drawing a predetermined trajectory when a state where the present value of the second value is larger than the present value of the first value continues in the result of comparison.

2. The method for flattening the power of the musical sound signal according to claim 1, wherein the power at the plurality of time points of the musical sound signal indicates power of each of a plurality of samples of the musical sound signal, or power of a plurality of peaks extracted from the plurality of samples.

3. The method for flattening the power of the musical sound signal according to claim 1, wherein in the comparison, after a first value larger than the present value of the second value is set as a present value of a new second value, if a present value of a first value larger than the present value of the new second value does not appear in a first period, the predetermined trajectory draws a first straight line that maintains the present value of the new second value in the first period, and further if the present value of the first value larger than the present value of the new second value does not appear in a second period continuous with the first period, the predetermined trajectory draws a second straight line in which the present value of the second value at a start point of the second period becomes 0 at an end point of the second period,
when the present value of the first value is larger than the present value of the second value, determining the present value of the first value as a corresponding second value, and when the present value of the first value is smaller than the present value of the second value, determining the corresponding second value according to the first straight line and the second straight line, and
flattening of the plurality of first values or reducing of the difference of the plurality of first values is performed by dividing each of the plurality of first values by the corresponding second value, or multiplying each of the plurality of first values by a reciprocal of the corresponding second value.

4. An information processing device, comprising:
a control part performing a process of determining a second value corresponding to each of a plurality of first values indicating power at a plurality of time points of a musical sound signal based on a result of comparison between a present value of the first value and a present value of the second value, and a process of flattening the plurality of first values or a process of reducing the difference of the plurality of first values by using the second value corresponding to each of the plurality of first values,
wherein the second value changes by drawing a predetermined trajectory when a state where the present value of the second value is larger than the present value of the first value continues in the result of comparison.

5. A method for detecting a beat timing of a musical piece, comprising:
determining a second value corresponding to each of a plurality of first values indicating power at a plurality of time points of a musical sound signal of the musical piece based on a result of comparison between a present value of the first value and a present value of the second value;
flattening the plurality of first values or reducing the difference of the plurality of first values by using a plurality of second values corresponding to each of the plurality of first values; and
detecting the beat timing using the plurality of first values that is flattened or that the difference of the plurality of first values is reduced,
wherein the second value changes by drawing a predetermined trajectory when a state where the present value of the second value is larger than the present value of the first value continues in the result of comparison.

6. The method for detecting the beat timing of the musical piece according to claim 5, wherein the power at the plurality of time points of the musical sound signal indicates power of each of a plurality of samples of the musical sound signal, or power of a plurality of peaks extracted from the plurality of samples.

7. The method for detecting the beat timing of the musical piece according to claim 5, wherein in the comparison, after a first value larger than the present value of the second value is set as a present value of a new second value, if a present value of a first value larger than the present value of the new second value does not appear in a first period, the predetermined trajectory draws a first straight line that maintains the present value of the new second value in the first period, and further if the present value of the first value larger than the present value of the new second value does not appear in a second period continuous with the first period, the predetermined trajectory draws a second straight line in which the present value of the second value at a start point of the second period becomes 0 at an end point of the second period,
when the present value of the first value is larger than the present value of the second value, determining the present value of the first value as a corresponding second value, and when the present value of the first value is smaller than the present value of the second value, determining the corresponding second value according to the first straight line and the second straight line, and
flattening of the plurality of first values or reducing the difference of the plurality of first values is performed by dividing each of the plurality of first values by the corresponding second value, or multiplying each of the plurality of first values by a reciprocal of the corresponding second value.

8. The method for detecting the beat timing of the musical piece according to claim 6, wherein each power of each of the plurality of samples of the musical sound signal indicates a sum of power of each frequency bandwidth obtained by a fast Fourier transform by acquiring a frame composed of a predetermined number of continuous sound samples from data of the musical piece, thinning samples in the frame, and performing the fast Fourier transform on thinned samples.

9. The method for detecting the beat timing of the musical piece according to claim 6, wherein each power of a plurality of peaks extracted from the plurality of samples indicates power when a state where power indicating a value larger than itself, among power of each of the plurality of samples, does not appear continues for a predetermined time.

10. The method for detecting the beat timing of the musical piece according to claim 6, wherein:
flattening the power of the plurality of peaks;
calculating a period and a phase of a beat of the musical piece using the power of the plurality of peaks flattened; and
detecting the beat timing of the musical piece based on the period and the phase of the beat.

11. The method for detecting the beat timing of the musical piece according to claim 10, wherein
performing a Fourier transform on the power of the plurality of peaks flattened for a predetermined time, and calculates a BPM (Beats Per Minute), as the period of the beat of the musical piece, when an absolute value of a value of the Fourier transform becomes a maximum value; and
calculating a relative position, as the phase of the beat, of a generation timing of a beat sound in a sine wave indicating the BPM.

12. The method for detecting the beat timing of the musical piece according to claim 10, performing, with respect to a plurality of BPM (Beats Per Minute), a Fourier transform having an attenuation term on the power of the plurality of peaks flattened, and calculating a BPM, as the period of the beat of the musical piece, when an absolute value of a value of the Fourier transform becomes a maximum value.

13. The method for detecting the beat timing of the musical piece according to claim 12, performing the Fourier transform on a plurality of values, which are obtained by multiplying each of window functions shifted by 1/n period of the BPM corresponding to the period of the beat of the musical piece by the power of the plurality of peaks flattened, to obtain a plurality of wavelet transform values, and calculating a phase, as the phase of the beat of the musical piece, when an absolute value of the plurality of wavelet transforms becomes maximum.

14. The method for detecting the beat timing of the musical piece according to claim 10, obtaining a count value indicating the period of the beat and the phase of the beat, times the count value using a counter that increments a sampling rate for each sample, and detecting a timing at which a value of the counter reaches the count value as the beat timing.

15. A device for detecting a beat timing of a musical piece, comprising:
a control part performing a process of determining a second value corresponding to each of a plurality of first values indicating power at a plurality of time points of a musical sound signal of the musical piece based on a result of comparison between a present value of the first value and a present value of the second value, a process of flattening the plurality of first values or a process of reducing the difference of the plurality of first values by using a plurality of second values corresponding to the plurality of first values, and a process of detecting the beat timing using the plurality of first values that is flattened or that the difference of the plurality of first values is reduced,
wherein the second value changes by drawing a predetermined trajectory when a state where the present value of the second value is larger than the present value of the first value continues in the result of comparison.

16. The method for flattening the power of the musical sound signal according to claim 2, wherein in the comparison, after a first value larger than the present value of the second value is set as a present value of a new second value, if a present value of a first value larger than the present value of the new second value does not appear in a first period, the predetermined trajectory draws a first straight line that maintains the present value of the new second value in the first period, and further if the present value of the first value larger than the present value of the new second value does not appear in a second period continuous with the first period, the predetermined trajectory draws a second straight line in which the present value of the second value at a start point of the second period becomes 0 at an end point of the second period,
when the present value of the first value is larger than the present value of the second value, determining the present value of the first value as a corresponding second value, and when the present value of the first value is smaller than the present value of the second value, determining the corresponding second value according to the first straight line and the second straight line, and
flattening of the plurality of first values or reducing the difference of the plurality of first values is performed by dividing each of the plurality of first values by the corresponding second value, or multiplying each of the plurality of first values by a reciprocal of the corresponding second value.

17. The method for detecting the beat timing of the musical piece according to claim 6, wherein in the comparison, after a first value larger than the present value of the second value is set as a present value of a new second value, if a present value of a first value larger than the present value of the new second value does not appear in a first period, the predetermined trajectory draws a first straight line that maintains the present value of the new second value in the first period, and further if the present value of the first value larger than the present value of the new second value does not appear in a second period continuous with the first period, the predetermined trajectory draws a second straight line in which the present value of the second value at a start point of the second period becomes 0 at an end point of the second period,
when the present value of the first value is larger than the present value of the second value, determining the present value of the first value as a corresponding second value, and when the present value of the first value is smaller than the present value of the second value, determining the corresponding second value according to the first straight line and the second straight line, and
flattening of the plurality of first values or reducing the difference of the plurality of first values is performed by dividing each of the plurality of first values by the corresponding second value, or multiplying each of the plurality of first values by a reciprocal of the corresponding second value.

18. The method for detecting the beat timing of the musical piece according to claim 7, wherein each power of each of the plurality of samples of the musical sound signal indicates a sum of power of each frequency bandwidth obtained by a fast Fourier transform by acquiring a frame composed of a predetermined number of continuous sound samples from data of the musical piece, thinning samples in the frame, and performing the fast Fourier transform on thinned samples.

19. The method for detecting the beat timing of the musical piece according to claim 17, wherein each power of each of the plurality of samples of the musical sound signal indicates a sum of power of each frequency bandwidth obtained by a fast Fourier transform by acquiring a frame composed of a predetermined number of continuous sound samples from data of the musical piece, thinning samples in the frame, and performing the fast Fourier transform on thinned samples.

20. The method for detecting the beat timing of the musical piece according to claim 7, wherein each power of a plurality of peaks extracted from the plurality of samples indicates power when a state where power indicating a value larger than itself, among power of each of the plurality of samples, does not appear continues for a predetermined time.
